(19) United States
(12) Patent Application Publication
(10) Pub. No.: US 2015/0170676 A1
(43) Pub. Date: Jun. 18, 2015

(54) SKEW-AWARE DISK FORMAT FOR ARRAY READER BASED MAGNETIC RECORDING

(71) Applicant: LSI Corporation, San Jose, CA (US)

(72) Inventors: Eui Seok Hwang, Palo Alto, CA (US); George Mathew, San Jose, CA (US); Jongseung Park, Allentown, PA (US)

(73) Assignee: LSI Corporation, San Jose, CA (US)

(21) Appl. No.: 14/172,869

(22) Filed: Feb. 4, 2014

Related U.S. Application Data
(60) Provisional application No. 61/916,789, filed on Dec. 16, 2013.

(51) Int. Cl. G11B 5/09

(52) U.S. Cl. CPC G11B 5/09

(57) ABSTRACT

A method of reading data in a multi-reader two-dimensional magnetic recording system includes determining a position of a multi-reader head, selecting a mode for reading the data of a magnetic recording medium as a function of the position of the multi-reader head, and reading the data of the magnetic recording medium in the selected mode.

### CROSS-REFERENCE TO RELATED APPLICATIONS

This application claims the benefit of U.S. Provisional Patent Application No. 61/916,789 filed on Dec. 16, 2013, the complete disclosure of which is expressly incorporated by reference herein in its entirety for all purposes.

### TECHNICAL FIELD

The present invention relates generally to electrical and electronic circuitry, and more particularly relates to reading and writing a magnetic recording in a system having multiple sensors.

### BACKGROUND

The magnetic disk drive recording industry continues to pursue advances in technology that will sustain enhancements in recording density in a cost-effective manner. Two approaches currently under investigation are bit patterned media recording (BPMR) and heat-assisted magnetic recording (HAMR). An objective of these approaches is to overcome challenges posed by the super-paramagnetic limit that imposes a trade-off among three fundamentally competing recording parameters: media signal-to-noise ratio (SNR), writability, and thermal stability. BPMR and HAMR, however, require modifications to the media and heads, which significantly increase costs. Another technology, two-dimensional magnetic recording (TDMR), which uses conventional media and a new multiple-head configuration, relies on powerful signal processing in an attempt to achieve a theoretical limit of one bit-per-grain recording density.

As a practical near-term milestone, array-reader based magnetic recording (ARMR) has been proposed to increase areal density with an array-reader and associated signal processing.

### SUMMARY

In accordance with an embodiment of the invention, a method of reading data in a multi-reader two-dimensional magnetic recording system includes determining a position of a multi-reader head, selecting a mode for reading the data of a magnetic recording medium as a function of the position of the multi-reader head, and reading the data of the magnetic recording medium in the selected mode. Other embodiments of the invention include, but are not limited to, being manifest as a TDMR read circuit fabricated as part of an integrated circuit, a method for improving read performance of a magnetic disk, and an electronic system. Additional and/or other embodiments of the invention are described in the following written description, including the claims, which is to be read in connection with the accompanying drawings.

### BRIEF DESCRIPTION OF THE FIGURES

The following drawings are presented by way of example only and without limitation, wherein like reference numerals (when used) indicate corresponding elements throughout the several views, and wherein:

FIG. 1 depicts a storage device including an array-reader mode switching circuitry in accordance with one or more embodiments of the present invention;

FIGS. 2A-C illustrate skew angle and reader cross-talk separation (CTS) in accordance with one or more embodiments of the present invention;

FIG. 3 is a graph of CTS versus down-track separation (DTS) between readers in accordance with one or more embodiments of the present invention;

FIG. 4 illustrates various skew angles and associated read modes of a multi-reader head in accordance with one or more embodiments of the present invention for a CTS between readers;

FIG. 5 illustrates various skew angles and associated read modes of a multi-reader head in accordance with one or more embodiments of the present invention for another CTS between readers;

FIG. 6A is a flow diagram of a method for zone table update in accordance with one or more embodiments of the present invention;

FIG. 6B includes graphs illustrating performance evaluations according to FIG. 6A;

FIG. 6C shows a graph of CTS as a function of skew angle according to FIG. 6A;

FIG. 7A is a diagram of a read path in accordance with one or more embodiments of the present invention; and

FIG. 7B is a flow diagram of a method for reading data in a selected mode in accordance with one or more embodiments of the present invention.

It is to be appreciated that the drawings described herein are presented for illustrative purposes only. Moreover, common but well-understood elements and/or features that may be useful or necessary in a commercially feasible embodiment may not be shown in order to facilitate a less hindered view of the illustrated embodiments.

### DETAILED DESCRIPTION

Embodiments of the invention will be described herein in the context of illustrative array-reader based magnetic recording (ARMR) systems for use, for example, in a data storage application. It should be understood, however, that embodiments of the invention are not limited to these or any other particular ARMR arrangements. Rather, embodiments of the invention are more broadly applicable to techniques for improving read performance of a magnetic storage device. In this regard, embodiments of the invention provide an apparatus and methodology for beneficially mitigating an impact of skew angle and cross-track separation (CTS) between readers in an ARMR system by switching of an array-reader mode for different skew zones. Moreover, it will become apparent to those skilled in the art given the teachings herein that numerous modifications can be made to the illustrative embodiments shown that are within the scope of the claimed invention. That is, no limitations with respect to the embodiments shown and described herein are intended or should be inferred.

As a preliminary matter, for purposes of clarifying and describing embodiments of the invention, the following table provides a summary of certain acronyms and their corresponding definitions, as the terms are used herein:

Table of Acronym Definitions

| Acronym | Definition |
|---|---|
| BPMR | Bit patterned media recording |
| HAMR | Heat-assisted magnetic recording |
| SNR | Signal-to-noise ratio |
| TDMR | Two-dimensional magnetic recording |
| ARMR | Array-reader based magnetic recording |
| PMR | Perpendicular magnetic recording |
| TP | Track pitch |
| MISO | Multiple input single output |
| MIMO | Multiple input multiple output |
| kBPI | Kilo-bits per inch |
| kTPI | Kilo-tracks per inch |
| ITI | Inter-track interference |
| ASIC | Application-specific integrated circuit |
| DTS | Down-track separation (between readers) |
| CTS | Cross-track separation (between readers) |
| ID | Inner diameter of the disk |
| MD | Mid diameter of the disk |
| OD | Outer diameter of the disk |
| OTER | On-Track Error Rate |
| OTC | Off-Track Capability |
| BER | Bit Error Rate |

As previously stated, one problem with bit patterned media recording (BPMR) and heat-assisted magnetic recording (HAMR) is that these approaches require substantial modifications to the media and heads, which significantly increases costs. ARMR is seen as an intermediate approach between current perpendicular magnetic recording (PMR) and two-dimensional magnetic recording (TDMR), which provides a significant increase in storage density compared to PMR while avoiding the challenges posed by BPMR and HAMR. ARMR uses standard media and an array of read-elements, also referred to herein as a multi-reader head, in conjunction with changes in read-back signal processing to achieve improved signal-to-noise ratio (SNR) of a track that is being read (ARMR-MISO) or multiple tracks that are jointly read (ARMR-MIMO).

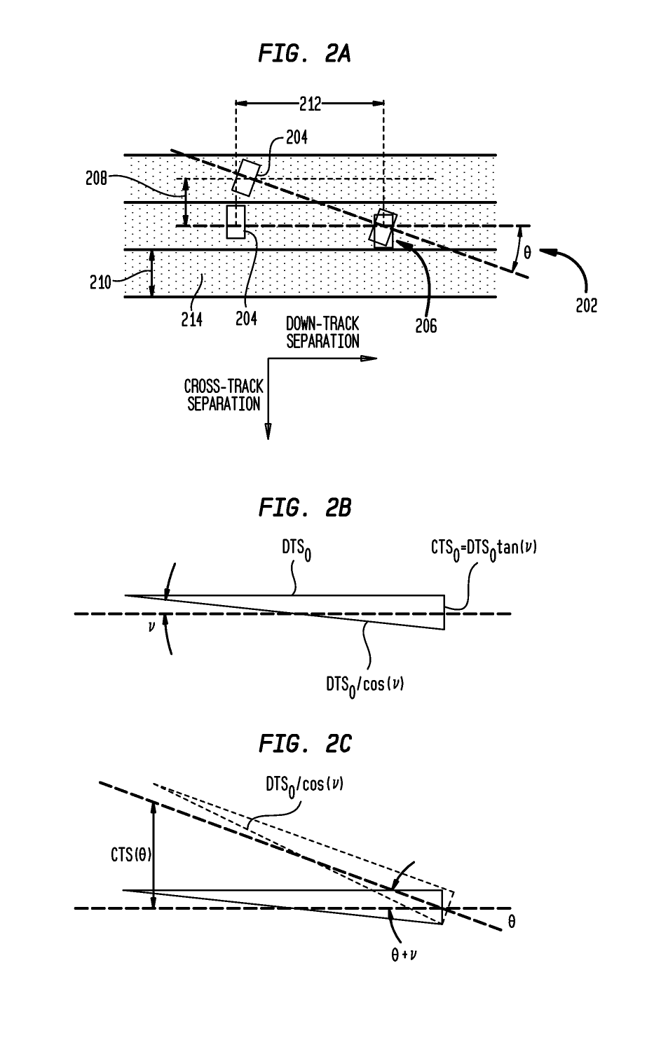

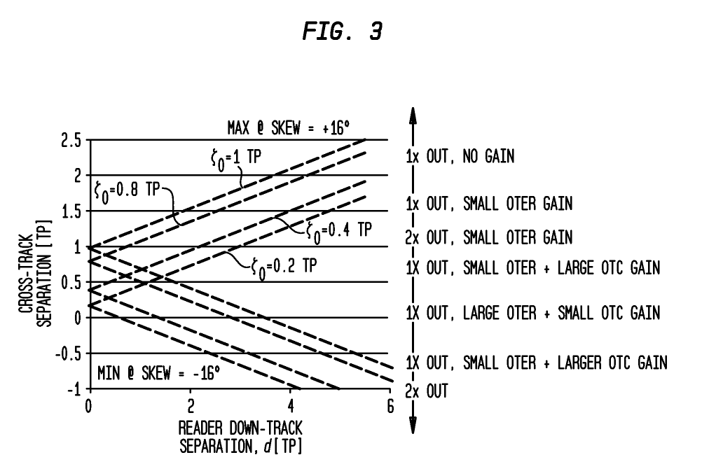

ARMR achieves an areal density gain by employing multi-dimensional joint signal processing of multiple read-back signals from the array reader. Embodiments of the invention are shown and described herein in the context of a multi-reader head including two read-elements (i.e., readers) that are positioned according to a prescribed CTS and down-track separation (DTS). Due to skew, among other factors (e.g., temperature, vibration, etc.), the effective CTS between readers varies. Further, the larger the DTS between read-elements without skew, denoted by DTS₀ or d, the more the CTS will vary with skew. This is illustrated in FIGS. 2A-C and FIG. 3, which are further described herein. While exemplary embodiments of the invention are described herein in the context of a multi-reader head including two read-elements, it is to be appreciated that embodiments of the invention are not limited to any specific number of read-elements.

TDMR is a known recording architecture intended to support storage densities beyond those of conventional recording systems. TDMR utilizes multiple read-elements to read from multiple adjacent tracks and uses joint signal processing and detection to decode the signal from a target track. The gains achieved from TDMR come primarily from more powerful coding and signal processing algorithms that allow data bits to be stored more densely on a magnetic storage medium (e.g., disk). In traditional disk architectures with a single read-element, reading a single sector with TDMR generally involves reading the sectors on adjacent tracks, requiring additional disk rotations. To circumvent this problem, TDMR disk drives may use multiple read-elements, also referred to as a multi-reader head, on the same support arm, typically referred to as a slider, thus restoring traditional read service times through ARMR processes. One disadvantage of using a multi-reader approach is that multiple readers are reading different off-track locations due to the CTS varying with skew. Although manufacturers may provide the physical distances between the multiple read-elements, actual CTS between the read-elements can vary based on the skew angle of the multi-reader head to the data track and several other factors. The factors that may affect CTS include, but are not limited to, environmental factors, such as, for example, temperature and mechanical vibration, as well as manufacturing factors, such as, for example, skew between the slider and the disk surface, and alignment of the read-elements relative to one another and/or to the slider, among other factors.

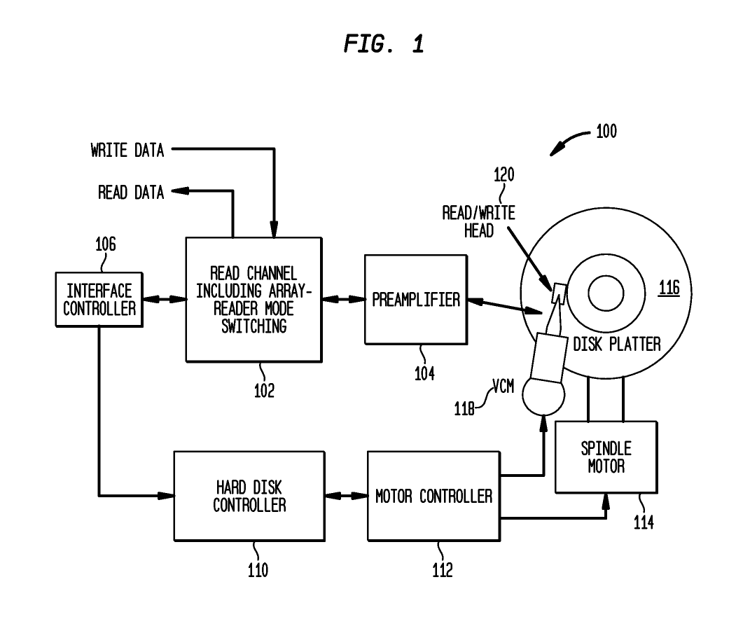

Turning to FIG. 1, a storage system 100 including a read channel circuit 102 having an array-reader mode switching circuitry is shown in accordance with some embodiments of the present invention. Storage system 100 also includes a preamplifier 104, an interface controller 106, a hard disk controller 110, a motor controller 112, a spindle motor 114, a disk platter 116, and a read/write head (or multi-reader head) assembly 120. The read/write head assembly 120 includes an array of readers or multiple read sensors in ARMR. In one embodiment, the interface controller 106 controls addressing and timing of data to and from the disk platter 116. The data on the disk platter 116 can be stored in the form of magnetic signals recorded in accordance with either a longitudinal or a perpendicular recording scheme. The data can be recovered or detected by the read/write head assembly 120 when the assembly is properly positioned over the disk platter 116. In one embodiment, the read/write head assembly 120 includes a voice coil motor (VCM) control module 118. The position of the read/write head assembly 120 can be determined by a detection device comprising one or more of the motor controller 112, the VCM control module 118, a dedicated sensor (not explicitly shown, but implied), etc. It is to be understood that embodiments of the invention are not limited to any specific storage system and that this disclosure is intended to cover any and all adaptations or variations of various embodiments configured to perform mode-based operations.

FIGS. 2A-C illustrate how reader CTS varies with skew angle 202. In FIG. 2A a multi-reader head is illustrated as being disposed at two different skew angles, 0 and θ. It follows that the difference between the two different skew angles is θ 202. The multi-reader head includes two readers, 204 and 206, shown disposed relative to one another for each of the two skew angles. A certain CTS 208 occurs between the two readers given the skew angle θ is represented by ζ(θ), also denoted by CTS (θ). Note that DTS 212 decreases with increasing skew angle. It should also be understood that, in one or more embodiments, CTS and DTS are measured in terms of track pitch (TP) 210 (three tracks, e.g., 214, are shown in FIG. 2A). For example, DTS=2 TP means that the down-track separation of two readers of the multi-reader head is equal to two times the track pitch, irrespective of skew angle.

FIG. 2B illustrates the CTS and DTS between two readers at 0 degree skew angle, denoted by CTS₀ and DTS₀, respectively, with v denoting an angle of separation between the readers at 0 skew. It should be understood that a multi-reader head having a shorter DTS experiences smaller CTS variations for the same skew angle (e.g., CTS variation is smaller for a multi-reader head having DTS=2 TP, compared to that of a multi-reader head having DTS=6 TP).

From FIG. 2C, a relationship describing the variation of CTS with skew angle for given DTS₀ and CTS₀ can be written as:

$$\begin{matrix}CTS ( θ ) = {DTS}_{0} / cos v sin ( θ + v ) \\ = {DTS}_{0} / cos v ( sin ( θ ) cos ( v ) + cos ( θ ) sin ( v ) )\end{matrix} \\ -> CTS ( θ ) = {DTS}_{0} sin ( θ ) + {CTS}_{0} cos ( θ ) ∼ {CTS}_{0} + {DTS}_{0} θ for small θ .$$

Here, a small θ can be between about −16 degrees and +16 degrees. In another embodiment, the range of θ is between about −16 degrees and +20 degrees. It is to be appreciated, however, that embodiments of the invention are not limited to any specific angle or range of angles. Different hardware (e.g., disk platters and read-elements) can have different ranges.

FIG. 3 shows that CTS variation increases with DTS₀ between read-elements. In FIG. 3, ζ₀ (or CTS₀) indicates the CTS at zero skew and the x-axis d denotes the DTS at zero skew, also denoted as DTS₀. Both CTS₀ and DTS₀ vary from sample to sample (i.e., between different hardware examples). According to the illustrative embodiment depicted in FIG. 3, the maximum CTS of a multi-reader head having a track pitch of 0.2 TP at zero skew is labeled as ζ₀=0.2 TP; for this multi-reader head, CTS varies between −1 TP at −16 degrees skew and about +1.25 TP at +16 degrees skew for DTS₀=4 TP.

These variations in CTS for a given multi-reader head can result in different conditions at different skew angles, including a multiple input single output (MISO—1× out) condition (i.e., multiple read-elements disposed over the same track), and a multiple input multiple output (MIMO—2× out) condition (i.e., multiple read-elements disposed over different tracks).

According to exemplary embodiments of the invention, the read hardware switches between a multiple input single output (MISO) mode and a multiple input multiple output (MIMO) mode as a function of the skew angle θ or resulting CTS(θ). Here, MISO mode refers to a condition where multiple readers are disposed over one track to recover data from that track, and MIMO refers to a condition where multiple readers are disposed over multiple tracks to recover data from more than one track.

As shown in FIG. 3, the performance of a system utilizing ARMR, in accordance with one or more embodiments, depends upon the CTS between readers, which is, in turn, dependent on a skew angle of the read-elements. For example, at CTS=+/−1 TP, two tracks can be detected in MIMO mode and throughput can be doubled (2×) compared to single-track detection.

In another example, at CTS=2 TP, a 1× throughput (corresponding to the MISO mode) can be achieved. As can be seen from FIG. 3, the performance of a system according to an embodiment of the present disclosure varies gradually with skew angle, and 2× throughput can be achieved by switching to the MIMO mode at appropriate regions of the disk.

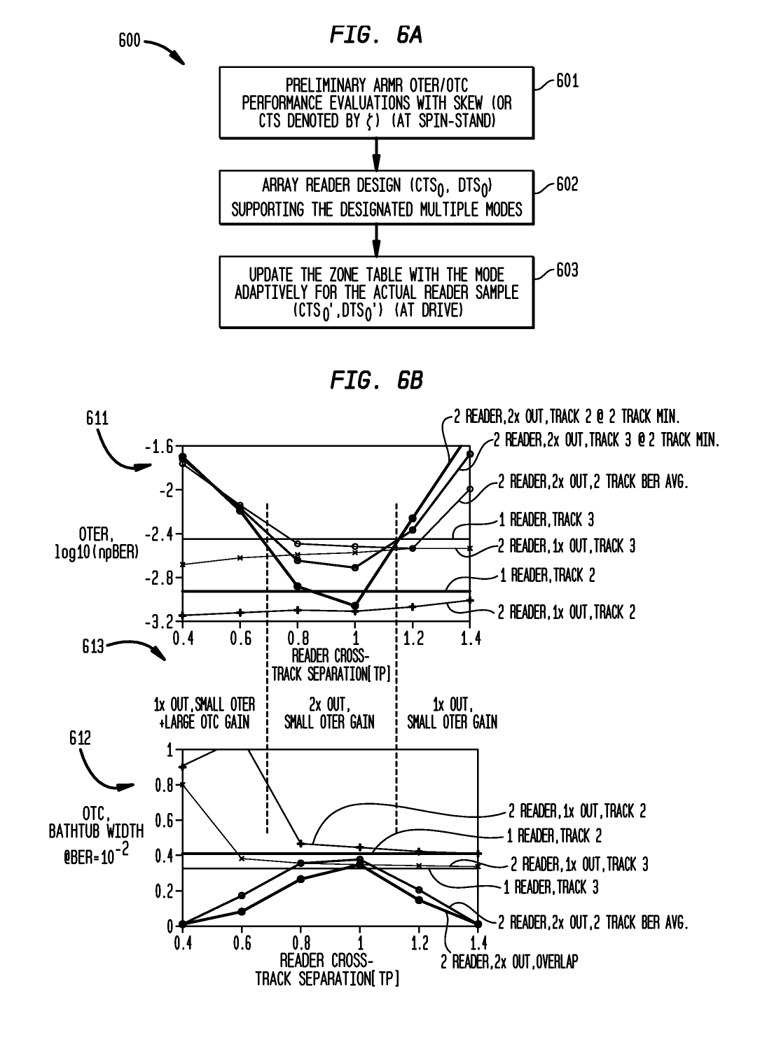

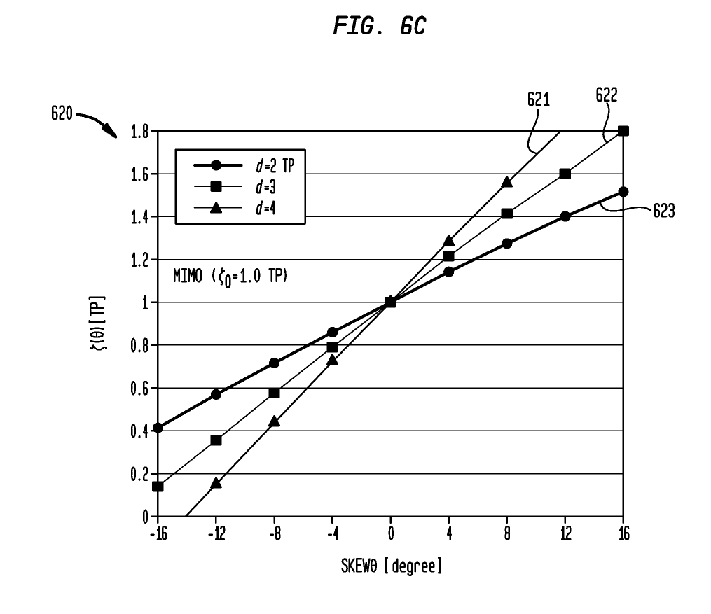

FIG. 3 further shows relative performance gains for on-track error rate (OTER) and off-track capability (OTC) for different values of CTS. The OTER performance and OTC performance can be determined from scans of bit error rate with certain read offsets, e.g., −50% of track pitch to +50% track pitch, where the log of the bit error rate is graphed versus read offset creating a curve similar to a bathtub or inverted bell curve. In one embodiment, the OTER is the lowest bit error rate (see for example, graph 611 of FIG. 6B which shows OTER for each CTS), and OTC is half of a width of the bathtub curve at a target bit error rate, e.g., 10^{-1.5} (see for example, graph 612 of FIG. 6B which shows OTC for each CTS).

Depending upon a number of readers, CTS and DTS among individual readers, and the skew angle, different zones on the medium can be independently optimized for throughput and capacity. This also means different signal-to-noise-ratio (SNR) versus throughput for different zones. Embodiments of the invention, therefore, utilize switching of an array-reader mode for different skew zones as a function of CTS between readers to provide additional performance and/or areal density gains. Furthermore, one or more embodiments of the invention target different zones on the medium to serve different applications, which can have different requirements. These requirements can correspond to throughput and capacity. It is to be understood that embodiments of the invention are not limited to any specific CTS.

Exemplary embodiments of the invention improve overall disk drive performance with a two reader ARMR through kilo-bits per inch (kBPI) (a measure of linear recording density) and kilo-tracks per inch (kTPI) (a measure of track density) push at an outer peripheral region (OD region/large area), increasing overall per platter areal density significantly. It is to be understood that embodiments of the invention are not limited to any specific number of readers.

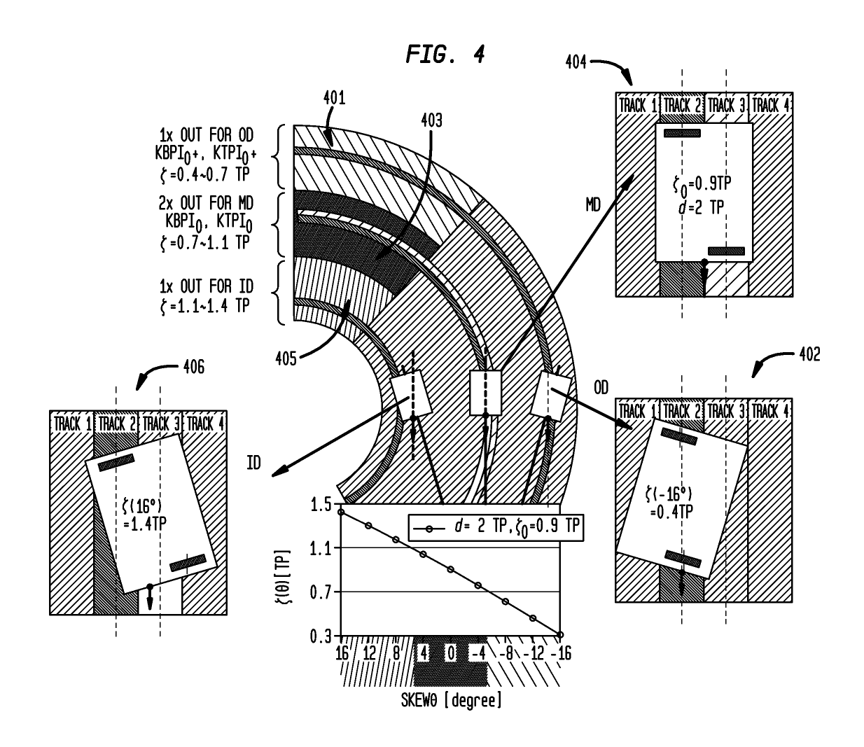

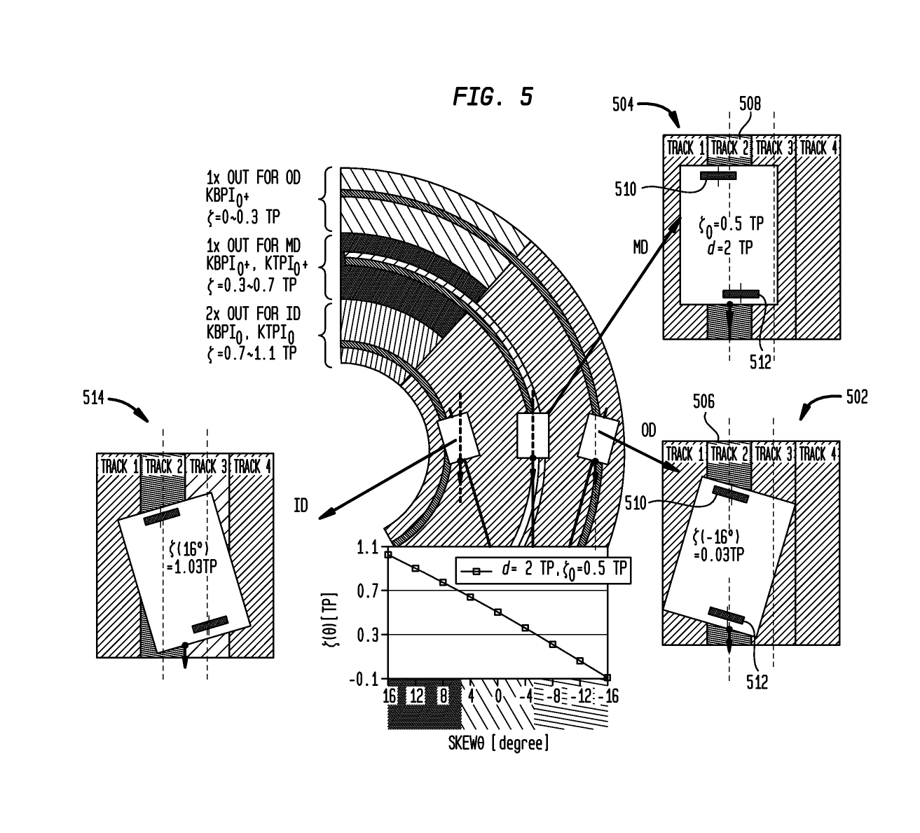

FIGS. 4 and 5 show exemplary cases of using 2-reader based ARMR for partitioning the zones of the storage medium based on various combinations of performance metrics throughput and capacity depending upon the CTS and DTS of the array-reader and skew angle in the different zones. Referring to FIG. 4, where it is assumed that zero skew angle is at MD, for the head geometry shown, the CTS decreases as the multi-reader head moves towards the OD region resulting in good SNR gain in the read-back signal resulting in an increase in capacity at the OD 401/402. Similarly, at an intermediate area (MD) 403/404, a throughput increase of about two times can be achieved, increasing transfer rate for critical data. At an inner peripheral region (ID) 405/406, marginal gains can be achieved, in the case of the ID the area is small and any adverse impact can be minor.

Exemplary embodiments of the invention enable channel optimization for each of the different zones. Since the usage mode of the channel is different in different zones, the disk format (e.g., track density, linear density) is tailored for the different zones. Since an effective channel sensed by an array-reader changes in each zone because of skew, optimization of an equalizer and PR target zone-wise become important. Different structures of an equalizer (e.g., an equalizer configured for 2D equalization and joint-track equalization) and corresponding target and detector will be required in zones having different throughputs (e.g., from 1× to 2× throughput).

Exemplary embodiments of the invention determine a zero-skew zone of the platter for increasing disk capacity. Referring to FIG. 5, by choosing the zero-skew zone to be between the MD and the OD, it can be ensured that both read-elements are available to cover each track with small CTS in a wider area spanning OD to MD, delivering improved capacity in this area. As can be seen, the respective tracks (i.e., track 2 506 and 508) in the OD 502 and the MD 504, are read by both read-elements 510 and 512. For given CTS and DTS between the two read-elements 510 and 512, the track-pitch and zero-skew location can be designed to increase capacity at 1× throughput. The zones outside of the zero-skew zone can be divided into two regions including 1) zones at/around the MD having a capacity resulting from the use of two readers, detecting only one track; and 2) zones at/around the ID 514, where the two reader-array is disposed over two distinct tracks such that two tracks can be detected simultaneously with an increase in capacity (e.g., about 2-3%) as compared to the zones at the MD. Capacity and throughput enhancements in the regions identified above are enabled by an equalization and detection strategies. For example:

1) High capacity region OD to MD at 1× throughput: Joint equalization of two reader outputs to detect one track;

2) Modest capacity region around MD at 1× throughput: Joint equalizer configured to operate as an inter-track-interference canceller to detect one track; and

3) Low capacity region around ID at 2× throughput: Joint equalizer and joint detector to detect two tracks.

Referring now to FIGS. 6A-C, in at least one exemplary embodiment a method 600 for updating the zone table includes performance evaluations at different skew angles 601. Exemplary results are shown in FIG. 6B. Graph 611 of FIG. 6B shows relative OTER performance (i.e., the log of the bit error rate (BER)) graphed versus CTS (reader cross-track separation (ζ)) for various combinations of parameters (e.g., 1 reader, 2 reader, 1× mode, 2× mode, and track numbers). Track 2 and Track 3 in FIG. 6B correspond to tracks written with two different squeeze values (i.e., overlap allowed when writing the tracks), where Track 2 has a lower squeeze compared to Track 3. Graph 612 of FIG. 6B shows the OTC versus reader CTS for the various parameters. The combination of the graphs 611 and 612 yields data upon which a mode selection can be made. That is, at 613, different modes (e.g., 1× for MISO or 2× for MIMO) are shown corresponding to different values of CTS in graphs 611 and 612.

At block 602 of FIG. 6A an array reader is designed or provided, wherein the array reader supports multiple modes. Such a design may incorporate the different performance envelopes of the graph 620 of FIG. 6C (e.g., 621, 622, 623) in respective modes. The zone table, giving different combinations of skew angle and CTS, is accessible to the read channel is updated to include the mode data (e.g., MISO/MIMO mode and corresponding reader cross-track locations).

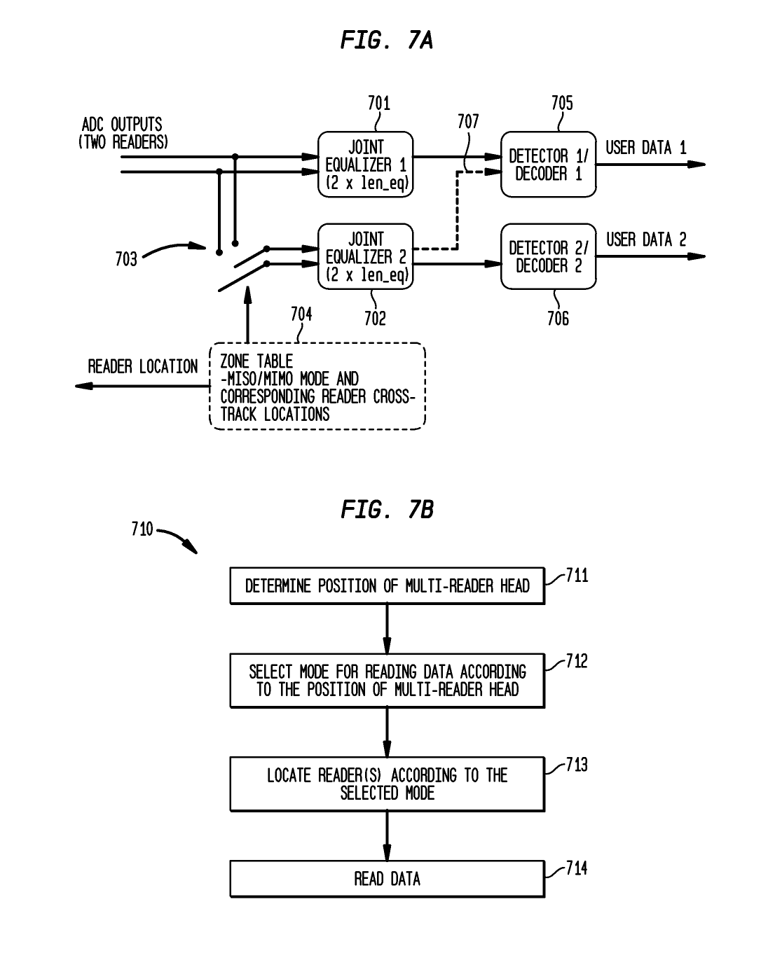

In one embodiment, the read channel 102 of FIG. 1 receives the outputs of two or more readers as shown in FIG. 7A, which are input to one or more joint equalizers (701, 702), depending on a state of a switch 703. In one embodiment, the state of the switch 703 is controlled according to a zone table 704 accessible to the read channel 102. That is, the read channel 102 determines the state of the switch 703 depending on a location of the read-elements and a corresponding entry on the zone table 704. It should be understood that the zone table 704 can be stored in any device accessible to the read channel 102. In one embodiment, the output(s) of the one or more joint equalizers (701, 702) is provided to one or more detectors (705, 706), which output user data. In one embodiment, a single detector/decoder (e.g., 705) can be used by scheduling the detector/decoder to process the equalized outputs of the joint equalizers (701, 702) selectively, where the output of joint equalizer 702 to the detector/decoder 705 is shown by 707.

In FIG. 7B, an exemplary method 710 of operating the read channel of FIG. 7A includes determining a position of a multi-reader head (711), selecting a mode for reading the data of a magnetic recording medium according to the position of the multi-reader head (712), locating one or more of the readers within one or more tracks of the magnetic recording medium according to the selected mode (713), and reading the data of the one or more tracks in the selected mode (714).

In one exemplary embodiment, determining the position at block 711 includes determining at which track(s) the multi-reader head disposed. It should be understood that the position can be determined by other methods (i.e., other than by track), including by region, skew angle, relative to a diameter of the magnetic recording medium, etc.

In one or more embodiments, the position of the multi-reader head is adjusted at block 713 to locate one or more of the readers within one or more tracks of the magnetic recording medium according to the selected mode. For example, in a case where the CTS of two readers of the multi-reader head is 1.5, only one track may be read using one reader. In this case, a 1× mode is selected based on the determination of the CTS using the zone table. Further, based on the selection of the 1× mode, the position of the multi-reader head is adjusted to locate the one reader of the multi-reader head in an approximate center of a corresponding track, while the remaining reader is allowed to be located at an approximate overlap of two adjacent tracks given the CTS of 1.5 (or without concern for its position) (essentially as shown in 406, FIG. 4). In the exemplary case, only the one reader is used in reading data since the remaining reader cannot be located to reliably read data.

It should be understood that the adjustment of the position of the multi-reader head based on the mode selection at block 713 is optional. Furthermore, it should be understood that the values used in the example are not intended to be limiting and that these values are only used for describing exemplary aspects of the invention.

As will be appreciated by one skilled in the art, embodiments of the present invention may be implemented as an apparatus, system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to as a “circuit,” “module” or “system.” Furthermore, embodiments of the present invention may take the form of a computer program product embodied in one or more non-transitory machine-readable medium(s) having machine-readable program code embodied thereon.

The block diagrams in the figures depict illustrative architectures, functionality, and operation of implementations of systems, methods and computer program products according to embodiments of the present invention. In this regard, each block shown in the block diagrams may represent a module, segment, or portion of code, which comprises one or more executable instructions for implementing specified functions. It should also be noted that, in one or more embodiments, functions represented by the blocks may occur out of the order noted in the figures. For example, two blocks shown in succession may, in fact, be executed substantially concurrently, or the blocks may sometimes be executed in the reverse order, depending upon the functionality involved. It will also be appreciated that each block of the block diagrams, and combinations of blocks in the block diagrams, can be implemented by special purpose hardware-based systems that perform the specified functions or acts, or combinations of special purpose hardware and computer instructions.

It should be understood that any of the methods described herein can include an additional step of providing a system comprising distinct software modules embodied on a non-transient computer-readable storage medium; the modules include, in one or more embodiments, any or all of the elements depicted in the block diagrams and/or described herein; by way of example and not limitation, a position determining module determining a position (e.g., track) of a multi-reader head (see for example, block 711, FIG. 7B), a mode selecting module reading data of a magnetic recording medium according to a position of the multi-reader head (see for example, block 712, FIG. 7B), and a data reading module reading data of the magnetic recording medium in the selected mode (see for example, block 714, FIG. 7B). The method steps can then be carried out using the distinct software modules and/or sub-modules of the system, executing on one or more hardware processors. Further, a computer program product can include a computer-readable storage medium with code adapted to be implemented to carry out one or more method steps described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

In an integrated circuit implementation of one or more embodiments of the invention, multiple identical die are typically fabricated in a repeated pattern on a surface of a semiconductor wafer. Each such die may include a device described herein, and may include other structures and/or circuits. The individual dies are cut or diced from the wafer, then packaged as integrated circuits. One skilled in the art would know how to dice wafers and package die to produce integrated circuits. Any of the exemplary circuits illustrated in the accompanying figures, or portions thereof, may be part of an integrated circuit. Integrated circuits so manufactured are considered part of this invention.

The illustrations of embodiments of the invention described herein are intended to provide a general understanding of the structure of various embodiments, and they are not intended to serve as a complete description of all the elements and features of apparatus and systems that might make use of the structures described herein. Many other embodiments will become apparent to those skilled in the art given the teachings herein; other embodiments are utilized and derived therefrom, such that structural and logical substitutions and changes can be made without departing from the scope of this disclosure. The drawings are also merely representational and are not drawn to scale. Accordingly, the specification and drawings are to be regarded in an illustrative rather than a restrictive sense.

Embodiments of the invention are referred to herein, individually and/or collectively, by the term “embodiment” merely for convenience and without intending to limit the scope of this application to any single embodiment or inventive concept if more than one is, in fact, shown. Thus, although specific embodiments have been illustrated and described herein, it should be understood that an arrangement achieving the same purpose can be substituted for the specific embodiment(s) shown; that is, this disclosure is intended to cover any and all adaptations or variations of various embodiments. Combinations of the above embodiments, and other embodiments not specifically described herein, will become apparent to those of skill in the art given the teachings herein.

The abstract is provided to comply with 37 C.F.R. §1.72(b), which requires an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the appended claims reflect, inventive subject matter lies in less than all features of a single embodiment. Thus the following claims are hereby incorporated into the Detailed Description, with each claim standing on its own as separately claimed subject matter.

Given the teachings of embodiments of the invention provided herein, one of ordinary skill in the art will be able to contemplate other implementations and applications of the techniques of embodiments of the invention. Although illustrative embodiments of the invention have been described herein with reference to the accompanying drawings, it is to be understood that embodiments of the invention are not limited to those precise embodiments, and that various other changes and modifications are made therein by one skilled in the art without departing from the scope of the appended claims.

What is claimed is:

1. A method of reading data in a multi-reader two-dimensional magnetic recording system, the method comprising:
determining a position of a multi-reader head;
selecting a mode for reading the data of a magnetic recording medium as a function of the position of the multi-reader head; and
reading the data of the magnetic recording medium in the selected mode.

2. The method of claim 1, wherein the position is determined relative to a diameter of the magnetic recording medium.

3. The method of claim 2, the method further comprising determining a cross-track spacing between readers of the multi-reader head that corresponds to the position of the multi-reader head, the step of selecting the mode further comprising reading a zone table to determine the mode corresponding to the cross-track spacing.

4. The method of claim 1, wherein the position is determined relative to a track of the magnetic recording medium.

5. The method of claim 1, further comprising providing a zone table comprising indications of a plurality of modes, each mode corresponding to a different position of the multi-reader head.

6. The method of claim 5, wherein the step of selecting the mode further comprises reading the zone table to determine the mode corresponding to the position of the multi-reader head.

7. The method of claim 1, wherein the mode is a multiple input single output mode.

8. The method of claim 7, further comprising inputting the data read by one or more readers of the multi-reader head into one joint equalizer.

9. The method of claim 1, wherein the mode is a multiple input multiple output mode.

10. The method of claim 9, further comprising inputting the data read by each reader of the multi-reader head into respective joint equalizers.

11. The method of claim 1, further comprising locating one or more readers of the multi-reader head according to the selected mode.

12. A system for enhancing read performance in a multi-reader two-dimensional magnetic recording system, the system comprising:
a multi-reader head;
a detection device detecting a position of the multi-reader head;
a memory device storing a zone table; and
a read channel configured to select a mode for reading data from a magnetic recording medium as a function of a mode selected from the zone table corresponding to the position of the multi-reader head.

13. The system of claim 12, further comprising a motor controlling a rotation of the magnetic recording medium.

14. The system of claim 12, wherein the device detecting the position of the multi-reader head comprises a voice coil motor control module.

15. The system of claim 12, wherein the detection device detecting the position of the multi-reader head comprises a motor controller.

16. The system of claim 12, wherein the read channel comprises a plurality of joint equalizers.

17. The system of claim 16, wherein the plurality of joint equalizers are individually selected to receive an output of the multi-reader head according to the mode.

18. The system of claim 16, wherein the read channel comprises a plurality of detectors disposed in series with respective ones of the plurality of joint equalizers.

19. A computer program product embodied in a non-transitory machine-readable medium having machine-readable program code embodied thereon for performing a method of reading data in a multi-reader two-dimensional magnetic recording system, the method comprising:
determining a position of a multi-reader head;
selecting a mode for reading the data of a magnetic recording medium as a function of the position of the multi-reader head; and
reading the data of the magnetic recording medium in the selected mode.

20. The computer program product of claim 19, wherein the method further comprises providing a zone table comprising indications of a plurality of modes, each mode corresponding to a different position of the multi-reader head, wherein the selection of the mode further comprises reading the zone table to determine the mode corresponding to the position of the multi-reader head.
